(19) United States
(12) Patent Application Publication
(10) Pub. No.: US 2015/0341664 A1
(43) Pub. Date: Nov. 26, 2015

(54) METHOD AND APPARATUS OF DISPARITY VECTOR DERIVATION IN THREE-DIMENSIONAL VIDEO CODING

(71) Applicants: Yi-Wen CHEN, (US); Jian-Liang LIN, (US); Jicheng AN, (US); Kai ZHANG, (US); ZHANG, Na, Shangqiu, Henan (CN)

(72) Inventors: Na ZHANG, Shangqiu, Henan (CN); Yi-Wen CHEN, Taichung City (TW); Jian-Liang LIN, Su'ao Township, Yilan County (TW); Jicheng AN, Beijing (CN); Kai ZHANG, Beijing (CN)

(21) Appl. No.: 14/759,042

(22) PCT Filed: Dec. 13, 2013
(86) PCT No.: PCT/CN2013/089382

§ 371 Date: Jul. 2, 2015

Related U.S. Application Data
(63) Continuation of application No. PCT/CN2013/070278, filed on Jan. 9, 2013.

(51) Int. Cl. H04N 19/597; H04N 19/105; H04N 19/147; H04N 19/176

(52) U.S. Cl. CPC H04N 19/597; H04N 19/176; H04N 19/105; H04N 19/147

(57) ABSTRACT

A derived disparity vector is determined based on spatial neighboring blocks and temporal neighboring blocks of the current block. The temporal neighboring blocks are searched according to a temporal search order and the temporal search order is the same for all dependent views. Any temporal neighboring block from a CTU below the current CTU row may be omitted in the temporal search order. The derived DV can also be used for predicting a DV of a DCP (disparity-compensated prediction) block for the current block in the AMVP mode, the Skip mode or the Merge mode. The temporal neighboring blocks may correspond to a temporal CT block and a temporal BR block. In one embodiment, the temporal search order checks the temporal BR block first and the temporal CT block next.

### CROSS REFERENCE TO RELATED APPLICATIONS

The present invention is a National Phase application of PCT Application Serial No. PCT/CN2013/089382, filed on Dec. 13, 2013, which claims priority to PCT Patent Application, Serial No. PCT/CN2013/070278, filed on Jan. 9, 2013, entitled “Methods for Disparity Vector Derivation”. The PCT Patent Application is hereby incorporated by reference in its entirety.

### TECHNICAL FIELD

The present invention relates to video coding. In particular, the present invention relates to disparity vector derivation for inter-view motion prediction, inter-view residual prediction, or predicting the DV of DCP (disparity-compensated prediction) blocks in three-dimensional video coding and multi-view video coding.

### BACKGROUND

Three-dimensional (3D) television has been a technology trend in recent years that is targeted to bring viewers sensational viewing experience. Multi-view video is a technique to capture and render 3D video. The multi-view video is typically created by capturing a scene using multiple cameras simultaneously, where the multiple cameras are properly located so that each camera captures the scene from one viewpoint. The multi-view video with a large number of video sequences associated with the views represents a massive amount data. Accordingly, the multi-view video will require a large storage space to store and/or a high bandwidth to transmit. Therefore, multi-view video coding techniques have been developed in the field to reduce the required storage space and the transmission bandwidth. A straightforward approach may simply apply conventional video coding techniques to each single-view video sequence independently and disregard any correlation among different views. Such straightforward techniques would result in poor coding performance. In order to improve multi-view video coding efficiency, multi-view video coding always exploits inter-view redundancy. The disparity between two views is caused by the locations and angles of the two respective cameras.

To share the previously coded texture information of adjacent views, a technique known as disparity-compensated prediction (DCP) has been included in the HTM (High Efficiency Video Coding (HEVC)-based Test Model) software test platform as an alternative to motion-compensated prediction (MCP). MCP refers to Inter-picture prediction that uses previously coded pictures of the same view, while DCP refers to an Inter-picture prediction that uses previously coded pictures of other views in the same access unit. FIG. 1 illustrates an example of 3D video coding system incorporating MCP and DCP. The vector (110) used for DCP is termed as disparity vector (DV), which is analog to the motion vector (MV) used in MCP. FIG. 1 illustrates three MVs (120, 130 and 140) associated with MCP. Moreover, the DV of a DCP block can also be predicted by the disparity vector predictor (DVP) candidate derived from neighboring blocks or the temporal collocated blocks that also use inter-view reference pictures.

In order to share the previously encoded motion information of reference views, HTM-5.0 uses a coding tool termed as inter-view motion prediction. According to the inter-view motion prediction, a DV for a current block is derived first and the prediction block in the already coded picture in the reference view is located by adding the DV to the location of current block. If the prediction block is coded using MCP, the associated motion parameters of the prediction block can be used as candidate motion parameters for the current block in the current view. The derived DV can also be directly used as a candidate DV for DCP.

Inter-view residual prediction is another coding tool used in HTM-5.0. In order to share the previously encoded residual information of reference views, the residual signal for current block can be predicted by the residual signal of the corresponding blocks in reference views. The corresponding block in reference view is located by a DV.

For Merge mode in HTM-5.0, the candidate derivation also includes an inter-view motion vector. A Merge candidate list is first constructed and motion information of the Merge candidate with the smallest rate-distortion (RD) cost is selected as the motion information of Merge mode. For the texture component, the order of deriving Merge candidates is: temporal inter-view motion vector merging candidate, left (spatial), above (spatial), above-right (spatial), disparity inter-view motion vector Merge candidate, left-bottom (spatial), above-left (spatial), temporal and additional bi-predictive candidates. For the depth component, the order of deriving Merge candidates is: motion parameter inheritance (MPI), left (spatial), above (spatial), above-right (spatial), bottom-left (spatial), above-left (spatial), temporal and additional bi-predictive candidates. A DV is derived for the temporal inter-view motion vector Merge candidate and the derived DV is directly used as the disparity inter-view motion vector Merge candidate.

As mentioned above, various coding tools utilize a derived DV. Therefore, the DV is critical in 3D video coding for inter-view motion prediction, inter-view residual prediction, disparity-compensated prediction (DCP) or any other tools which need to indicate the correspondence between inter-view pictures. In HTM version 5.0, the disparity vector (DV) for a block can be derived so that the block can use the DV to specify the location of a corresponding block in an inter-view reference picture for the inter-view motion prediction and inter-view residual prediction. The DV is derived from spatial and temporal neighboring blocks according to a pre-defined order. The spatial neighboring blocks that DV derivation may use are shown in FIG. 2A. As shown in FIG. 2A, five spatial neighboring blocks may be used. The search order for the spatial neighboring blocks is A₁ (left), B₁ (above), B₀ (above-right), A₀ (bottom-left) and B₂ (above-left).

As shown in FIG. 2B, two temporal blocks (CT and RB/TL) can be used to derive the DV based on a temporal corresponding block. The center block (CT) is located at the center of the current block. Block BR corresponds to a bottom-right block across from the bottom-right corner of the current block. If block BR is not available, the top-left block (TL) is used. Up to two temporal collocated pictures from a current view can be searched to locate an available DV. The first collocated picture is the same as the collocated picture used for Temporal Motion Vector Prediction (TMVP) in HEVC, which is signaled in the slice header. The second picture is different from that used by TMVP and is derived from the reference picture lists with the ascending order of reference picture indices. The DV derived from temporal corresponding blocks is added into the candidate list.

The second picture selection is described as follows:

(i) A random access point (RAP) is searched in the reference picture lists. If a RAP is found, the RAP is used as the second picture and the derivation process is completed. In case that the RAP is not available for the current picture, go to step (ii).

(ii) A picture with the lowest temporallD (TID) is selected as the second temporal pictures. If multiple pictures with the same lowest TID exist, go to step (iii).

(iii) Within the multiple pictures with the same lowest TID, a picture of smaller POC difference with the current picture is chosen.

If any DCP coded block is not found in the above mentioned spatial and temporal neighboring blocks, the disparity information obtained from DV-MCP (disparity vector based motion compensated prediction) blocks are used. FIG. 3 illustrates an example of disparity vector based motion compensated prediction (DV-MCP). A disparity vector (314) associated with current block 322 of current picture 320 in a dependent view is determined. The disparity vector (314) is used to find a corresponding reference block (312) of an inter-view reference picture (310) in the reference view (e.g., a base view). The MV of the reference block (312) in the reference view is used as the inter-view MVP candidate of the current block (322). The disparity vector (314) can be derived from the disparity vector of neighboring blocks or the depth value of a corresponding depth point. The disparity vector used in the DV-MCP block represents a motion correspondence between the current and inter-view reference picture.

To indicate whether a MCP block is DV-MCP coded or not and to conserve data associated with the disparity vector used for the inter-view motion parameters prediction, two variables are added to store the motion vector information of each block: dvMcpFlag and dvMcpDisparity. When dvMcpFlag is equal to 1, dvMcpDisparity is set to the disparity vector used for the inter-view motion parameter prediction. In advanced motion vector prediction (AMVP) and Merge candidate list construction process, dvMcpFlag of the candidate is set to 1 only for the candidate generated by inter-view motion parameter prediction. When a block is Skip coded, no MVD (motion vector difference) data and residual data are signaled. Therefore, in HTM-5.0, only the disparity vector from Skip coded DV-MCP blocks is used for DV derivation. Furthermore, only the spatial neighboring DV-MCP blocks are searched using the searching order: A0, A1, B0, B1 and B2. The first block that has dvMcpFlag equal to 1 will be selected and its dvMcpDisparity will be used as derived DV for the current block.

In HTM-5.0, the temporal DV derivation uses different checking order for different dependent views. An exemplary flowchart of the temporal DV candidate checking order for the temporal DV derivation is shown in FIG. 4. The view identification (i.e., view_Id) is checked first in step 410. If the view identification is larger than 1, the process goes to step 420 to check whether temporal block BR is outside the image boundary. If temporal block is inside the boundary, the process goes to step 422 to check whether temporal block BR has a DV. If a DV exists for temporal block BR, the DV is used as the temporal DV. Otherwise, the process goes to step 426. If temporal block BR is outside the boundary, the process goes to step 424 to check whether temporal block TL has a DV. If a DV exists for temporal block TL, the DV is used as the temporal DV. Otherwise, the process goes to step 426. In step 426, the process checks whether temporal block CT has a DV. If a DV exists for temporal block CT, the DV is used as the temporal DV. Otherwise, the temporal DV is not available. The temporal DV derivation is then terminated.

If the view corresponds to view 1 in FIG. 4, the process checks whether temporal block CT has a DV as shown in step 430. If a DV exists, the DV is used as the temporal DV. Otherwise, the process goes to step 432 to check whether temporal block BR is outside the image boundary. If temporal block is inside the boundary, the process goes to step 434 to check whether temporal block BR has a DV. If a DV exists for temporal block BR, the DV is used as the temporal DV. Otherwise, the temporal DV is not available and the process is terminated. If temporal block BR is outside the boundary, the process goes to step 436 to check whether temporal block TL has a DV. If a DV exists for temporal block TL, the DV is used as the temporal DV. Otherwise, the temporal DV is not available and the process is then terminated.

FIG. 5A and FIG. 5B illustrate a comparison between the temporal DV derivation for view 1 and views with view index larger than 1 respectively. For view 1, the center block (i.e., CT) is searched first and the bottom-right block (i.e., BR) is searched next. If block BR is outside the image boundary, the top-left block (i.e., TL) is used. For views with view index larger than 1, block BR is searched first and block CT is searched next. If block BR is outside image boundary, block TL is used. The use of different checking orders for different dependent views will increase system complexity.

The overall DV derivation process according to HTM-5.0 is illustrated in FIG. 6. The DV derivation process searches the spatial DV candidates first to select a spatial DV as shown in step 610. Five spatial DV candidates (i.e., (A₀, A₁, B₀, B₁ and B₂)) are used as shown in FIG. 2A. If none of the neighboring block has a valid DV, the search process moves to the next step (i.e., step 620) to search temporal DV candidates. The temporal DV candidates include block CT and block BR as shown in FIG. 2B. If block BR is outside the image boundary, block TL is used. If no DV can be derived from temporal DV candidates either, the process use a DV derived from depth data of a corresponding depth block as shown in step 630.

In HTM-5.0, when deriving the DV from the temporal neighboring blocks, it allows to access the RB temporal block residing in the lower coding tree unit (CTU) rows as shown in FIG. 7A. The BR blocks for corresponding CU/PU are indicated by shaded BR boxes. However, the temporal MVP derivation for Merge mode and AMVP mode forbids the use of BR blocks from a CTU row below the current CTU row as shown in FIG. 7B. For example, two BR blocks (indicated by crosses) of the bottom neighboring CTU and one BR block (indicated by a cross) of the bottom-right neighboring CTU are not used by coding units (CUs)/prediction units (PUs) in the current CTU.

In HTM-5.0, when the BR blocks are outside the image boundary, neither the DV derivation process (FIG. 8A) nor the temporal MVP derivation process for Merge mode and AMVP mode (FIG. 8B) will use the BR blocks outside the image boundary. As mentioned before, the DV derivation process will use the temporal neighboring block TL when RB is outside the image boundary as shown in FIG. 8A. For example, there are five BR blocks outside the image boundary in FIG. 8A. Therefore, five corresponding TL blocks will be used to replace the five BR blocks. Block 810 happens to be an inside BR block for PUO as well as a TL block for PU5.

The DV derivation process varies depending on the view identification. Also, the usage of TL block when BR blocks are outside the image boundary is different between the DV derivation process and the temporal MVP derivation process for Merge/AMVP modes. The derivation process in the existing HTM-5.0 is also complicated. It is desirable to simplify the process while maintaining the performance as much as possible.

### SUMMARY

A method and apparatus for three-dimensional video coding and multi-view video coding are disclosed. Embodiments according to the present invention determine a derived a disparity vector (DV) based on spatial and temporal neighboring blocks. The temporal neighboring blocks are searched according to a temporal search order and the temporal search order is the same for all dependent views. Furthermore, any temporal neighboring block from a coding tree block (CTU) below the current CTU row is omitted in the temporal search order. The derived DV can be used for indicating a prediction block in a reference view for inter-view motion prediction of the current block in AMVP (advance motion vector prediction) mode, Skip mode or Merge mode. The derived DV can also be used for indicating a corresponding block in a reference view for inter-view residual prediction of the current block. The derived DV can also be used for predicting a DV of a DCP (disparity-compensated prediction) block for the current block in the AMVP mode, the Skip mode or the Merge mode. The temporal neighboring blocks may correspond to a temporal CT block and a temporal BR block. In one embodiment, the temporal search order checks the temporal BR block first and the temporal CT block next. The spatial neighboring blocks may correspond to at least one of a left block, an above block, an above-right block, a bottom-left block and an above-left block of the current block.

In one embodiment, if the temporal BR block is located in a lower coding tree unit (CTU), the temporal BR block is omitted from the temporal search order. In another embodiment, the temporal TL block is not included in the temporal neighboring blocks. In another embodiment, the temporal neighboring blocks for determining the derived DV are also used for determining a motion vector prediction (MVP) candidate used for the AMVP mode or the Merge mode. In another embodiment, the temporal neighboring blocks, the temporal searching order, and any constraint on the temporal neighboring blocks used to determine the derived DV are also used to derive the motion vector prediction (MVP) candidate used for the AMVP mode or the Merge mode.

One aspect of the present invention addresses the spatial-temporal search order among the spatial neighboring blocks and the temporal neighboring blocks. For example, the DVs of the temporal neighboring blocks are checked first; the DVs of the spatial neighboring blocks are checked next; and the DVs used by the spatial neighboring blocks for inter-view motion prediction are checked the last.

### BRIEF DESCRIPTION OF DRAWINGS

FIG. 1 illustrates an example of three-dimensional coding and multi-view coding, where both motion-compensated prediction and disparity-compensated prediction are used.

FIG. 2A-FIG. 2B illustrate respective spatial neighboring blocks and temporal neighboring blocks used by HTM-5.0 to derive disparity vector.

FIG. 3 illustrates disparity vector from motion compensated prediction (DV-MCP) blocks.

FIG. 4 illustrates exemplary derivation process for determining a derived disparity vector for the current dependent view with view index equal to 1 and the current dependent view with view index greater than 1.

FIG. 5A-FIG. 5B illustrate different temporal search orders of temporal neighboring blocks between view with view index equal to 1 and views with view index greater than 1.

FIG. 6 illustrates the checking order for spatial neighboring blocks and temporal neighboring blocks to derive a disparity vector according to HTM-5.0.

FIG. 7A illustrates an example of temporal BR block locations associated with CUs/PUs of a CTU around CTU boundaries for deriving a disparity vector according to HTM-5.0

FIG. 7B illustrates an example of temporal BR block locations associated with CUs/PUs of a CTU around CTU boundaries for deriving a temporal motion vector prediction (TMVP) in AMVP mode, Merge mode or Skip mode according to HTM-5.0

FIG. 8A illustrates an example of temporal BR block locations associated with CUs/PUs of a CTU around image boundaries for deriving a disparity vector according to HTM-5.0

FIG. 8B illustrates an example of temporal BR block locations associated with CUs/PUs of a CTU around image boundaries for deriving temporal motion vector prediction (TMVP) in AMVP mode, Merge mode or Skip mode according to HTM-5.0

FIG. 9A illustrates an example of unified temporal BR block locations associated with CUs/PUs of a CTU around CTU boundaries for deriving a disparity vector and temporal motion vector prediction (TMVP) in AMVP mode, Merge mode or Skip mode according to HTM-5.0.

FIG. 9B illustrates an example of unified temporal BR block locations associated with CUs/PUs of a CTU around image boundaries for deriving a disparity vector and temporal motion vector prediction (TMVP) in AMVP mode, Merge mode or Skip mode according to HTM-5.0.

FIG. 10A-FIG. 10D illustrate various spatial-temporal search orders for deriving disparity vector for a dependent view with view index equal to 1 and greater than 1 according to embodiments of the present invention.

FIG. 11 illustrates an exemplary flowchart of a 3D or multi-view coding system using a unified temporal search order during DV derivation, where the same temporal search order is used for dependent view with view index equal to 1 and greater than 1.

FIG. 12 illustrates an exemplary flowchart of a 3D or multi-view coding system using a temporal-temporal search order during DV derivation, where the temporal neighboring blocks are searched before the spatial neighboring blocks.

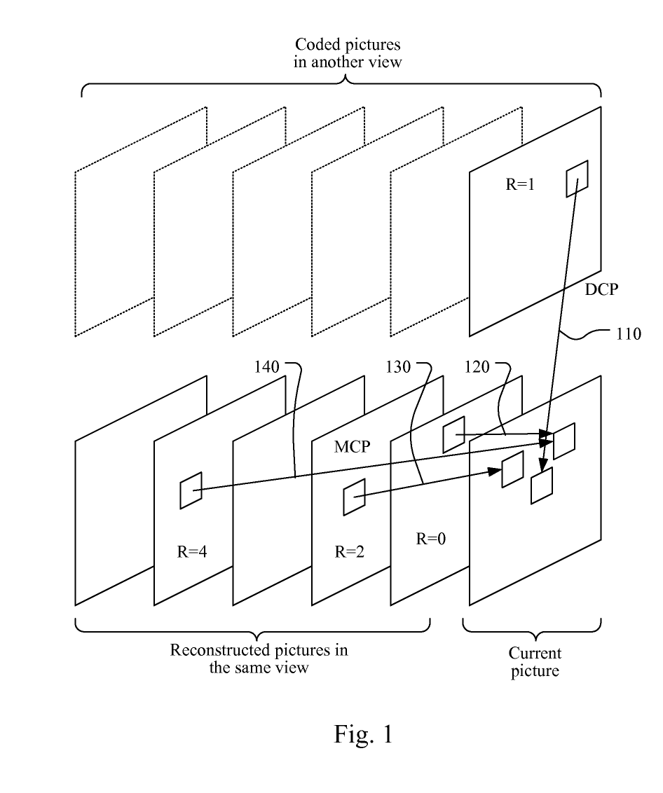

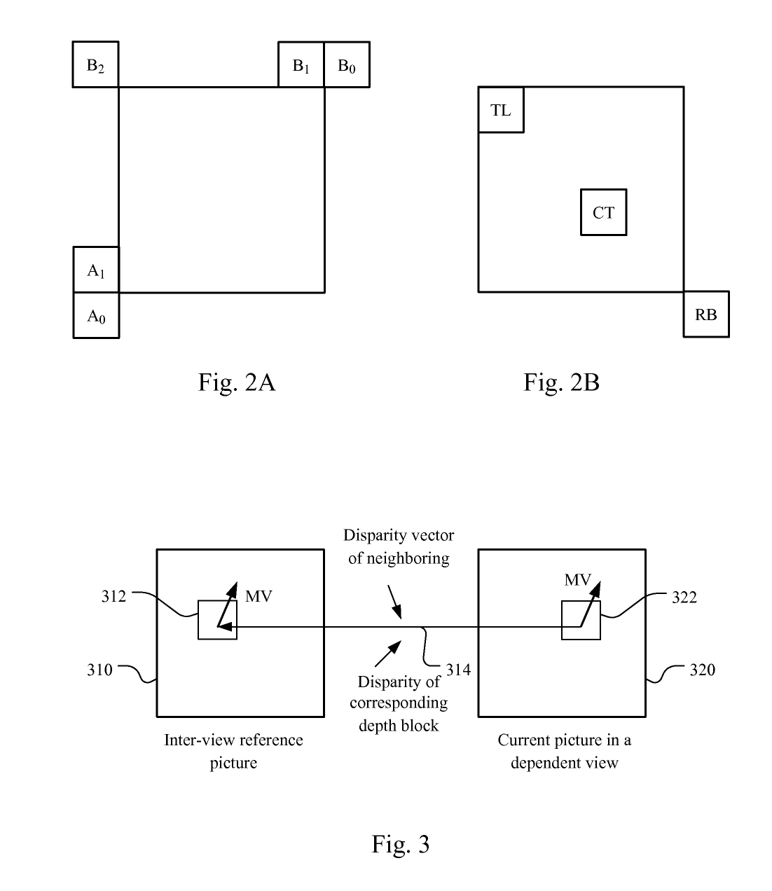

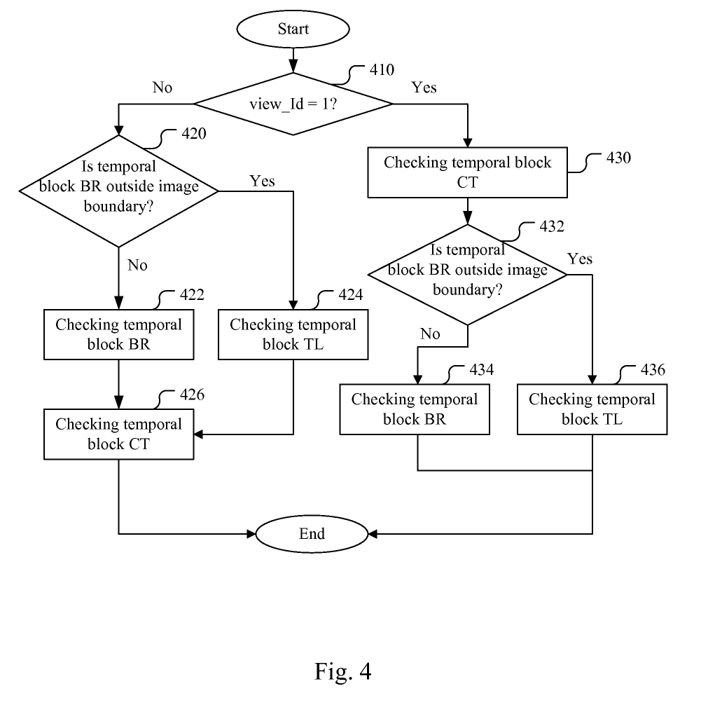

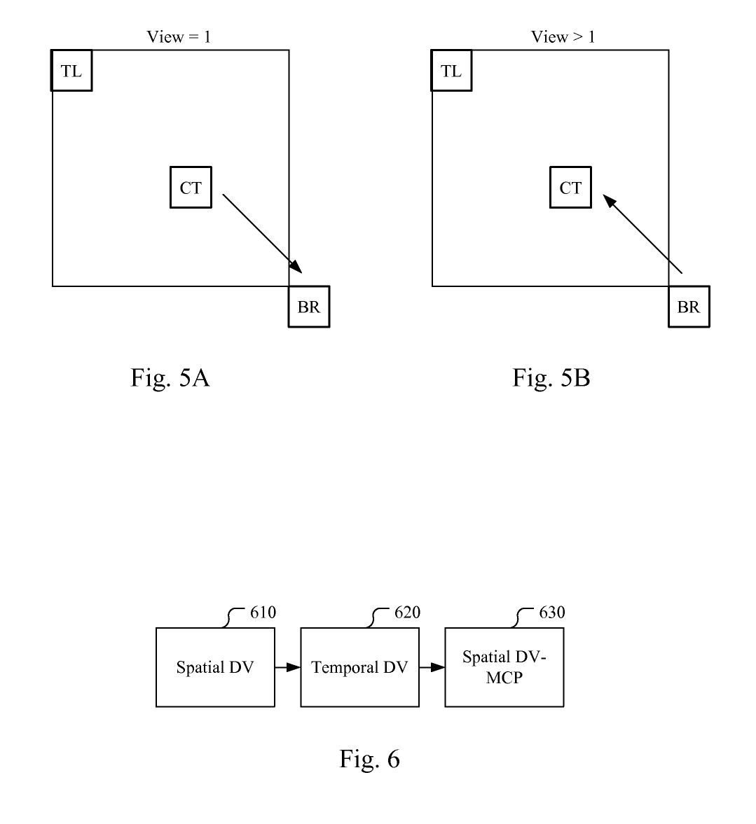

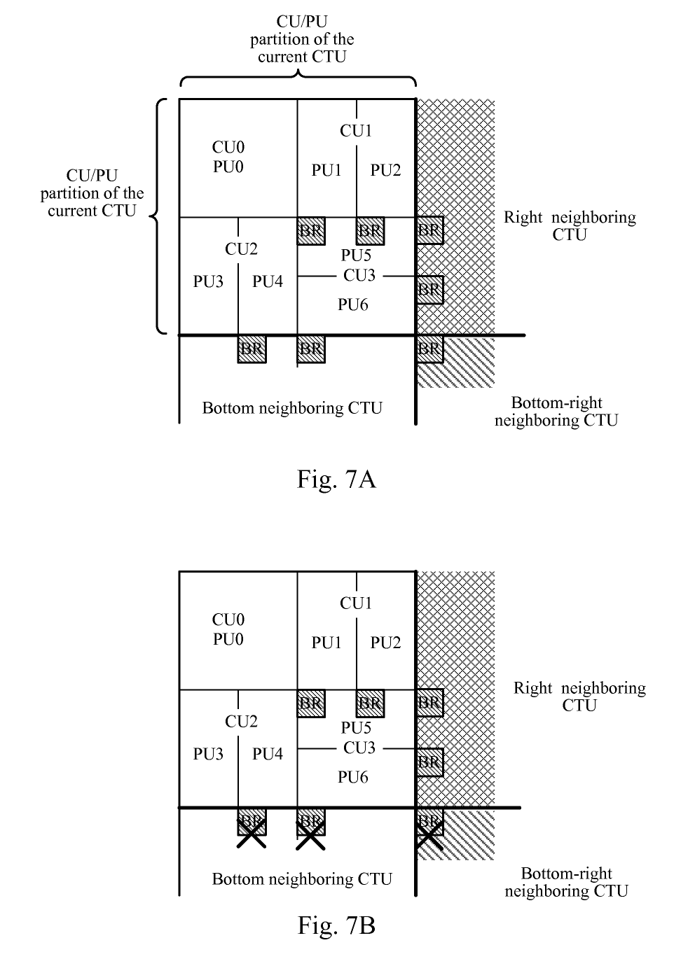

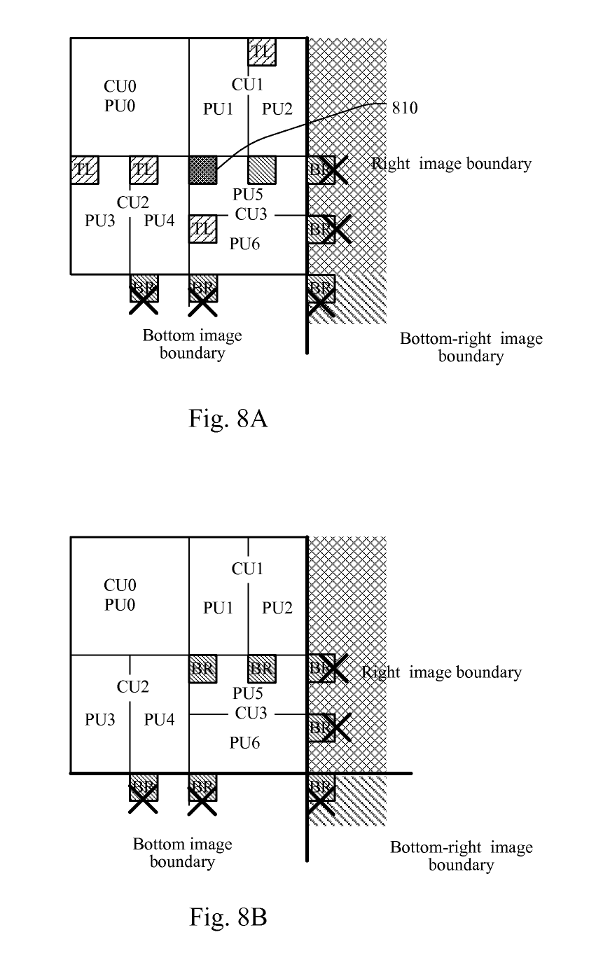

### DETAILED DESCRIPTION

As described above, there are various issues with the disparity vector (DV) derivation and motion vector prediction (MVP) derivation in three-dimensional (3D) and multi-view video coding in High Efficiency Video Coding (HEVC) based 3D/multi-view video coding. Embodiments of the present invention simplify the DV derivation and temporal MVP derivation in 3D and multi-view video coding based on HTM version 5.0 (HTM-5.0).

In one embodiment, the selection of temporal collocated picture for DV derivation is simplified. The temporal collocated picture used for the DV derivation could be signaled in a bitstream at the sequence level (SPS), view level (VPS), picture level (PPS) or slice level (slice header). The temporal collocated picture used for the DV derivation according to an embodiment of the present invention is derived at both the encoder side and the decoder side using the following procedure:

(1) A random access point (RAP) is searched in the reference picture lists. If a RAP is found, the RAP is used as the temporal picture and the derivation process is completed. In case that the RAP is not available for the current picture, go to step (2).

(2) A picture with the lowest temporal ID (TID) is set as the temporal picture. If multiple pictures with the same lowest TID exist, go to step (3).

(3) Within multiple pictures with the same lowest TID, a picture having smaller POC difference with the current picture is chosen.

The temporal collocated picture used for DV derivation can also be derived at both the encoder side and the decoder side using the following procedure:

(1) A random access point (RAP) is searched in the reference picture lists. If a RAP is found, the RAP is used as the temporal picture for DV derivation. In case that the RAP is not available for the current picture, go to step (2).

(2) The collocated picture used for Temporal Motion Vector Prediction (TMVP) as defined in the high efficiency video coding (HEVC) is used as the temporal picture for DV derivation.

In another embodiment of the present invention, the search order for different dependent views is unified. The unified search order may correspond to a search order that searches the temporal BR block first and the temporal CT block next. The unified search order may also correspond to a search order that searches the temporal CT block first and the temporal BR block next. Other unified search order may also be used to practice the present invention.

The performance of 3D/multi-view video coding system incorporating a unified search order for all dependent views (BR first and CT next) according to an embodiment of the present invention is compared with the performance of a system using the search orders based on conventional HTM-5.0 as shown in Table 1. The performance comparison is based on different sets of test data listed in the first column. The BD-rate differences are shown for texture pictures in view 1 (video 1) and view 2 (video 2). A negative value in the BD-rate implies the present invention has a better performance. As shown in Table 1, the BD-rate for texture pictures in view 1 and view 2 coded using the unified search order is the same as that of conventional HTM-5.0. The second group of performance is the bitrate measure for texture video only (Video only), the total bitrate for synthesized texture video (Synth. only) and the total bitrate for coded and synthesized video (Coded & synth.). As shown in Table 1, the average performance in this group is also about the same as the conventional HTM-5.0. The processing times (encoding time, decoding time and rendering time) are also compared. As shown in Table 1, the encoding time, decoding time and rendering all show some improvement (0.4 to 1.1%). Accordingly, in the above example, the system with a unified search order achieves about the same performance as conventional HTM-5.0.

TABLE 1

| | Video | Video | Video | Synth. | Coded & | Enc | Dec | Ren |
|---|---|---|---|---|---|---|---|---|
| | 1 | 2 | only | only | synth. | time | time | time |
| Balloons | 0.0% | 0.0% | 0.0% | 0.0% | 0.0% | 99.1% | 99.8% | 98.7% |
| Kendo | −0.3% | 0.0% | −0.1% | 0.0% | 0.0% | 98.1% | 98.6% | 95.8% |
| Newspapercc | 0.0% | 0.0% | 0.0% | 0.0% | 0.0% | 98.9% | 99.6% | 99.4% |
| GhostTownFly | 0.5% | 0.0% | 0.1% | 0.1% | 0.1% | 99.6% | 101.4% | 99.5% |
| PoznanHall2 | 0.1% | 0.0% | 0.0% | 0.1% | 0.1% | 98.7% | 99.6% | 98.3% |
| PoznanStreet | −0.2% | 0.0% | 0.0% | 0.0% | 0.0% | 99.7% | 98.7% | 100.9% |
| UndoDancer | 0.1% | 0.0% | 0.0% | −0.1% | 0.0% | 98.3% | 99.3% | 99.5% |
| 1024 × 768 | −0.1% | 0.0% | 0.0% | 0.0% | 0.0% | 98.7% | 99.3% | 98.0% |
| 1920 × 1088 | 0.2% | 0.0% | 0.0% | 0.0% | 0.0% | 99.1% | 99.8% | 99.6% |
| average | 0.0% | 0.0% | 0.0% | 0.0% | 0.0% | 98.9% | 99.6% | 98.9% |

In another embodiment of the present invention, the temporal TL block is removed in the DV derivation process so that the derivation process is aligned with the temporal MVP derivation process in Merge/AMVP modes.

The performance of 3D/multi-view video coding system with the TL block removed according to an embodiment of the present invention is compared with the performance of a system based on HTM-5.0 allowing the TL block as shown in Table 2. The BD-rate differences are shown for texture pictures in view 1 (video 1) and view 2 (video 2). As shown in Table 2, the BD-rate for texture pictures in view 1 and view 2 coded with the TL block removed is the same as that of conventional HTM-5.0. The second group of performance is the bitrate measure for texture video only (Video only), the total bitrate for synthesized texture video (Synth. only) and the total bitrate for coded and synthesized video (Coded & synth.). As shown in Table 2, the average performance in this group is also about the same as the conventional HTM-5.0. The processing times (encoding time, decoding time and rendering time) are also compared. As shown in Table 2, the encoding time, decoding time and rendering show some improvement (1.2 to 1.6%). Accordingly, in the above example, the system with the TL block removed achieves about the same performance as conventional HTM-5.0.

TABLE 2

| | Video | Video | Video | Synth. | Coded & | Enc | Dec | Ren |
|---|---|---|---|---|---|---|---|---|
| | 1 | 2 | only | only | synth. | time | time | time |
| Balloons | 0.0% | 0.0% | 0.0% | 0.0% | 0.0% | 98.7% | 101.7% | 97.5% |
| Kendo | 0.0% | 0.0% | 0.0% | 0.0% | 0.0% | 98.3% | 97.5% | 96.5% |
| Newspapercc | 0.0% | 0.0% | 0.0% | 0.0% | 0.0% | 98.9% | 100.8% | 99.1% |
| GhostTownFly | 0.0% | −0.1% | 0.0% | 0.0% | 0.0% | 98.8% | 97.9% | 98.4% |
| PoznanHall2 | −0.1% | 0.2% | 0.0% | 0.0% | 0.0% | 98.9% | 95.1% | 97.2% |
| PoznanStreet | −0.1% | −0.1% | 0.0% | 0.0% | 0.0% | 99.8% | 97.2% | 100.5% |
| UndoDancer | 0.0% | 0.0% | 0.0% | 0.0% | 0.0% | 98.3% | 95.9% | 99.4% |
| 1024 × 768 | 0.0% | 0.0% | 0.0% | 0.0% | 0.0% | 98.6% | 100.0% | 97.7% |
| 1920 × 1088 | 0.0% | 0.0% | 0.0% | 0.0% | 0.0% | 99.0% | 96.5% | 98.9% |
| average | 0.0% | 0.0% | 0.0% | 0.0% | 0.0% | 98.8% | 98.0% | 98.4% |

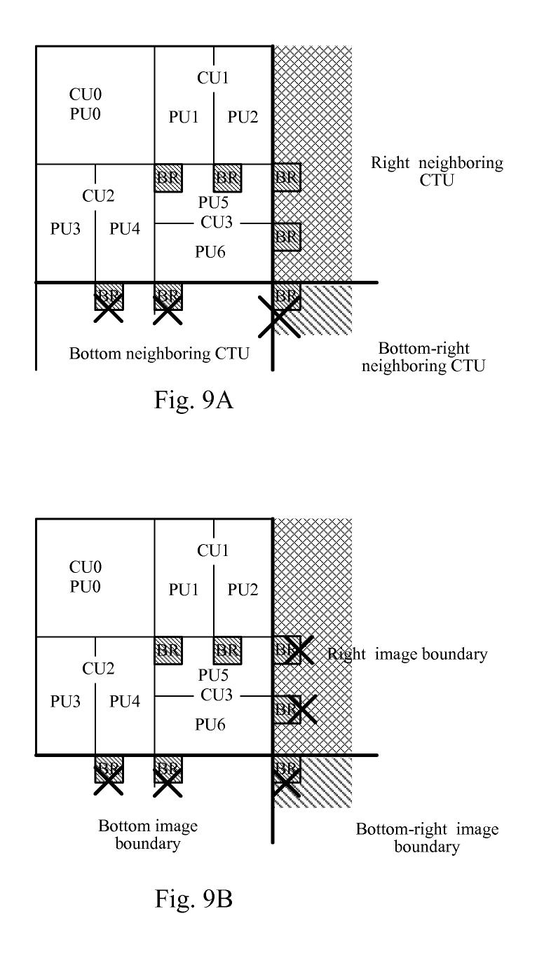

In another embodiment of the present invention, a unified temporal block usage for DV derivation and temporal MVP derivation in Merge/AMVP modes is disclosed. The unified temporal block usage may forbid BR usage if the BR block is located in a CTU (coding tree unit) row below the current CTU row as shown in FIG. 9A. In this case, the temporal BR block is considered as unavailable if the temporal BR block is in the CTU row below the current CTU row. The unified temporal block usage may also consider the BR block as unavailable if the BR block is outside the image boundary as shown in FIG. 9B. In this case, only the CT block is used.

The performance of 3D/multi-view video coding system incorporating a unified BR block usage according to an embodiment of the present invention is compared with the performance of a system based on the conventional HTM-5.0 as shown in Table 3. The BD-rate differences are shown for texture pictures in view 1 (video 1) and view 2 (video 2). As shown in Table 3, the BD-rate for texture pictures in view 1 coded using the unified BR block usage is the same as that of conventional HTM-5.0. The BD-rate for texture pictures in view 2 coded using the unified BR block usage incurs 0.3% loss compared to that of conventional HTM-5.0. The second group of performance is the bitrate measure for texture video only (Video only), the total bitrate for synthesized texture video (Synth. only) and the total bitrate for coded and synthesized video (Coded & synth.). As shown in Table 3, the average performance in this group is also about the same as the conventional HTM-5.0 except for the video only case, where it incurs 0.1% loss. The processing times (encoding time, decoding time and rendering time) are also compared. As shown in Table 3, the encoding time, decoding time and rendering show some improvement (0.6 to 1.4%). Accordingly, in the above example, the system with unified BR block usage achieves about the same performance as conventional HTM-5.0.

TABLE 3

| | Video | Video | Video | Synth. | Coded & | Enc | Dec | Ren |
|---|---|---|---|---|---|---|---|---|
| | 1 | 2 | only | only | synth. | time | time | time |
| Balloons | 0.1% | 0.5% | 0.1% | 0.1% | 0.1% | 98.8% | 97.9% | 97.8% |
| Kendo | 0.2% | 0.5% | 0.1% | 0.1% | 0.1% | 98.2% | 99.4% | 96.4% |
| Newspapercc | 0.0% | 0.0% | 0.0% | 0.0% | 0.0% | 98.5% | 99.0% | 99.1% |
| GhostTownFly | 0.1% | 0.1% | 0.0% | 0.0% | 0.0% | 98.8% | 100.3% | 99.2% |
| PoznanHall2 | 0.1% | 0.3% | 0.1% | 0.1% | 0.1% | 99.1% | 100.7% | 99.0% |
| PoznanStreet | −0.3% | 0.3% | 0.0% | 0.0% | 0.0% | 99.2% | 100.2% | 100.9% |
| UndoDancer | 0.0% | 0.0% | 0.0% | −0.1% | −0.1% | 97.9% | 98.6% | 100.6% |
| 1024 × 768 | 0.1% | 0.4% | 0.1% | 0.1% | 0.1% | 98.5% | 98.8% | 97.8% |
| 1920 × 1088 | 0.0% | 0.2% | 0.0% | 0.0% | 0.0% | 98.7% | 100.0% | 99.9% |
| average | 0.0% | 0.3% | 0.1% | 0.0% | 0.0% | 98.6% | 99.4% | 99.0% |

The performance for a system incorporating combined simplifications including a unified search order for all dependent views (BR first and CT next), TL block removal and unified BR block usage is compared against that of the HTM-5.0 as shown in Table 4. The BD-rate differences are shown for texture pictures in view 1 (video 1) and view 2 (video 2). As shown in Table 4, the BD-rate for texture pictures in view 1 coded using the unified BR block usage is the same as that of conventional HTM-5.0. The BD-rate for texture pictures in view 2 coded using the combined simplification incurs 0.2% loss compared to that of conventional HTM-5.0. The second group of performance is the bitrate measure for texture video only (Video only), the total bitrate for synthesized texture video (Synth. only) and the total bitrate for coded and synthesized video (Coded & synth.). As shown in Table 4, the average performance in this group is also about the same as the conventional HTM-5.0 except for the video only case, where it incurs 0.1% loss. The processing times (encoding time, decoding time and rendering time) are also compared. As shown in Table 4, the encoding time, decoding time and rendering show some improvement (0.5 to 1.7%). Accordingly, in the above example, the system with the combined simplifications achieves about the same performance as conventional HTM-5.0.

TABLE 4

| | Video | Video | Video | Synth. | Coded & | Enc | Dec | Ren |
|---|---|---|---|---|---|---|---|---|
| | 1 | 2 | only | only | synth. | time | time | time |
| Balloons | 0.1% | 0.5% | 0.1% | 0.1% | 0.1% | 98.8% | 97.9% | 97.8% |
| Kendo | 0.2% | 0.5% | 0.1% | 0.1% | 0.1% | 98.2% | 99.4% | 96.4% |
| Newspapercc | 0.0% | 0.0% | 0.0% | 0.0% | 0.0% | 98.5% | 99.0% | 99.1% |
| GhostTownFly | 0.1% | 0.1% | 0.0% | 0.0% | 0.0% | 98.8% | 100.3% | 99.2% |
| PoznanHall2 | 0.1% | 0.3% | 0.1% | 0.1% | 0.1% | 99.1% | 100.7% | 99.0% |
| PoznanStreet | −0.3% | 0.3% | 0.0% | 0.0% | 0.0% | 99.2% | 100.2% | 100.9% |
| UndoDancer | 0.0% | 0.0% | 0.0% | −0.1% | −0.1% | 97.9% | 98.6% | 100.6% |
| 1024 × 768 | 0.1% | 0.4% | 0.1% | 0.1% | 0.1% | 98.5% | 98.8% | 97.8% |
| 1920 × 1088 | 0.0% | 0.2% | 0.0% | 0.0% | 0.0% | 98.7% | 100.0% | 99.9% |
| average | 0.0% | 0.3% | 0.1% | 0.0% | 0.0% | 98.6% | 99.4% | 99.0% |

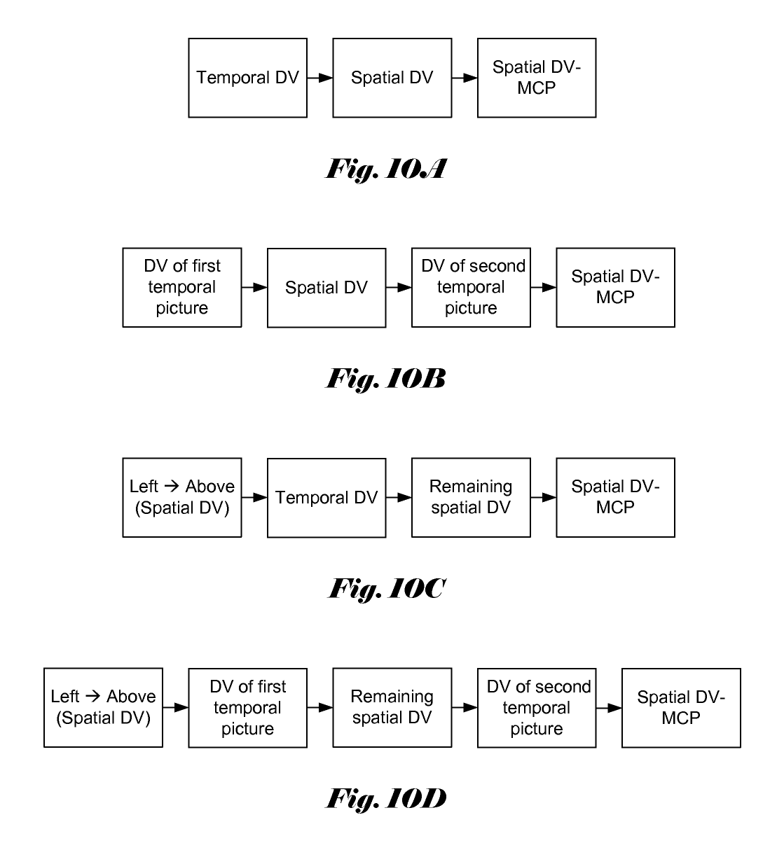

In yet another embodiment of the present invention, a new candidate checking order for DV derivation is disclosed. The candidate checking order for DV derivation may correspond to temporal DV, spatial DV (A₁, B₁, B₀, A₀, B₂) and spatial DV-MCP (A₀, A₁, B₀, B₁, B₂) as shown in FIG. 10A. The candidate checking order for DV derivation may correspond to the DV of the first temporal picture, spatial DV (A₁, B₁, B₀, A₀, B₂), the DV of the second temporal picture, spatial DV-MCP (A₀, A₁, B₀, B₁, B₂) as shown in FIG. 10B. The candidate checking order for DV derivation may correspond to spatial DV (A₁, B₁), temporal DV, spatial DV (B₀, A₀, B₂), spatial DV-MCP (A₀, A₁, B₀, B₁, B₂) as shown in FIG. 10C. The candidate checking order for DV derivation may correspond to spatial DV (A₁, B₁), DV of the first temporal picture, spatial DV (B₀, A₀, B₂), DV of the second temporal picture, spatial DV-MCP (A₁, B₁) as shown in FIG. 10D.

Another embodiment of the present invention places the disparity inter-view motion vector Merge candidate in a position of the Merge candidate list adaptively. In the first example, if the temporal neighboring block has a DV, the disparity inter-view motion vector Merge candidate is placed at the first position (i.e., the position with index 0) of the Merge candidate list. Otherwise, the candidate is placed at the fourth position of the Merge candidate list. In the second example, if the temporal neighboring block in the first temporal picture has a DV, the disparity inter-view motion vector Merge candidate is placed at the first position of the Merge candidate list. Otherwise, the candidate is placed at the fourth position of the Merge candidate list. In the third example, if the spatial neighboring block has a DV, the disparity inter-view motion vector Merge candidate is placed at the first position of the Merge candidate list. Otherwise, the candidate is placed at the fourth position of the Merge candidate list. In the fourth example, if the spatial neighboring block or the temporal neighboring block in the first temporal picture has a DV, the disparity inter-view motion vector Merge candidate is placed at the first position of the Merge candidate list. Otherwise, the candidate is placed at the fourth position of the Merge candidate list. In the fifth example, if the spatial neighboring block or the temporal neighboring block has a DV, the disparity inter-view motion vector Merge candidate is placed at the first position of the Merge candidate list. Otherwise, the candidate is placed at the fourth position of the Merge candidate list. Other methods for adaptively placing the disparity inter-view motion vector Merge candidate in a position of the Merge candidate list for texture coding can also be supported.

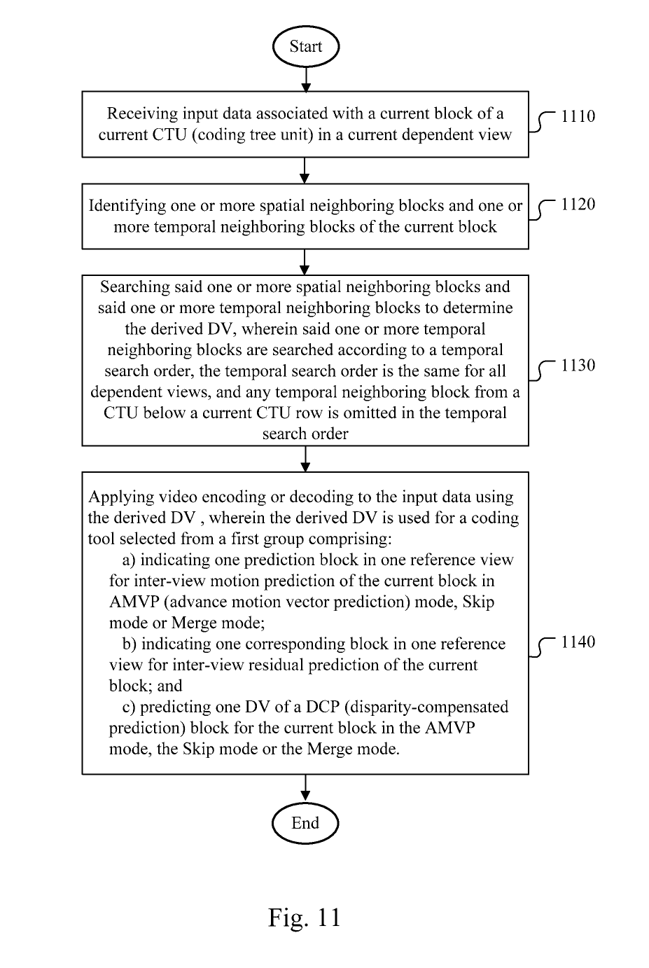

FIG. 11 illustrates an exemplary flowchart of a three-dimensional/multi-view coding system incorporating a unified temporal search order according to an embodiment of the present invention. The system receives input data associated with a current block of a current CTU (coding tree unit) in a current dependent view as shown in step 1110. For encoding, the input data associated with the current block corresponds to original pixel data, depth data, or other information associated with the current block (e.g., motion vector, disparity vector, motion vector difference, or disparity vector difference) to be coded. For decoding, the input data corresponds to the coded data associated with the current block in the dependent view. The input data may be retrieved from storage such as a computer memory, buffer (RAM or DRAM) or other media. The input data may also be received from a processor such as a controller, a central processing unit, a digital signal processor or electronic circuits that produce the input data. The spatial neighboring blocks and temporal neighboring blocks of the current block are identified as shown in step 1120. The spatial neighboring blocks and the temporal neighboring blocks are searched to determine the derived DV as shown in step 1130, wherein the temporal neighboring blocks are searched according to a temporal search order, the temporal search order is the same for all dependent view and any temporal neighboring block from a CTU below the current CTU row is omitted in the temporal search order. Video encoding or decoding is then applied to the input data using the derived DV, wherein the derived DV is used for a coding tool selected from a first group as shown in step 1140. The derived DV can be used to indicate a prediction block in a reference view for inter-view motion prediction of the current block in AMVP (advance motion vector prediction) mode, Skip mode or Merge mode. The derived DV can be used to indicate a corresponding block in a reference view for inter-view residual prediction of the current block. The derived DV can also be used to predict a DV of a DCP (disparity-compensated prediction) block for the current block in the AMVP mode, the Skip mode or the Merge mode.

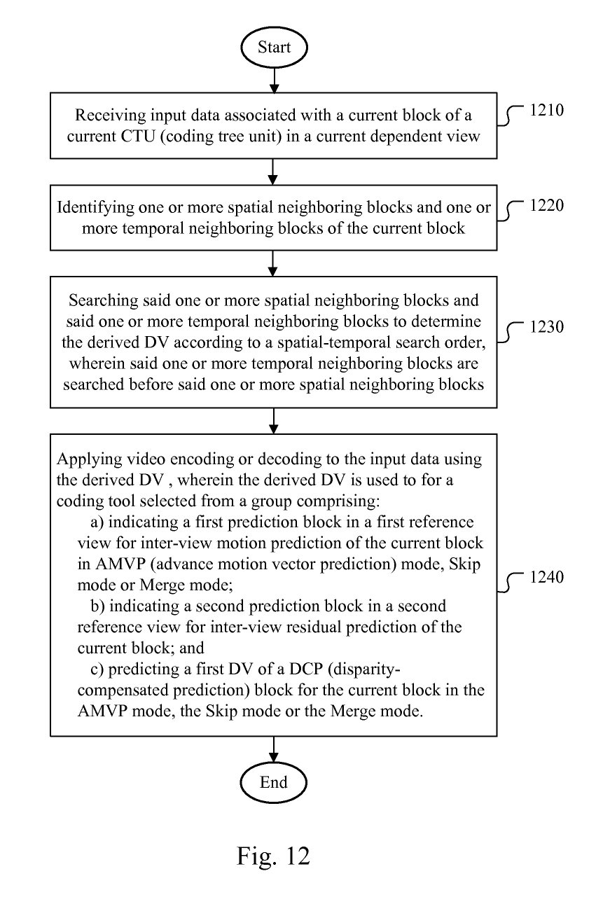

FIG. 12 illustrates another exemplary flowchart of a three-dimensional/multi-view coding system incorporating a unified spatial-temporal search order according to an embodiment of the present invention. The system receives input data associated with a current block of a current CTU (coding tree unit) in a current dependent view as shown in step 1210. The spatial neighboring blocks and temporal neighboring blocks of the current block are identified as shown in step 1220. The spatial neighboring blocks and the temporal neighboring blocks are searched to determine the derived DV according to a spatial-temporal search order as shown in step 1230, wherein the temporal neighboring blocks are searched before the spatial neighboring blocks. Video encoding or decoding is then applied to the input data using the derived DV, wherein the derived DV is used for a coding tool selected from a group as shown in step 1240. The derived DV can be used to indicate a prediction block in a reference view for inter-view motion prediction of the current block in AMVP (advance motion vector prediction) mode, Skip mode or Merge mode. The derived DV can be used to indicate a corresponding block in a reference view for inter-view residual prediction of the current block. The derived DV can also be used to predict a DV of a DCP (disparity-compensated prediction) block for the current block in the AMVP mode, the Skip mode or the Merge mode.

The flowcharts shown above are intended to illustrate examples of simplified/unified search orders. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding a block using a derived DV (disparity vector) for a three-dimensional or multi-view video coding system, the method comprising:
receiving input data associated with a current block of a current CTU (coding tree unit) in a current dependent view;
identifying one or more spatial neighboring blocks and one or more temporal neighboring blocks of the current block;
searching said one or more spatial neighboring blocks and said one or more temporal neighboring blocks to determine the derived DV, wherein said one or more temporal neighboring blocks are searched according to a temporal search order, the temporal search order is the same for all dependent views, and any temporal neighboring block from a CTU below a current CTU row is omitted in the temporal search order; and
applying video encoding or decoding to the input data using the derived DV, wherein the derived DV is used for a coding tool selected from a first group comprising:
a) indicating one prediction block in one reference view for inter-view motion prediction of the current block in AMVP (advance motion vector prediction) mode, Skip mode or Merge mode;
b) indicating one corresponding block in one reference view for inter-view residual prediction of the current block; and
c) predicting one DV of a DCP (disparity-compensated prediction) block for the current block in the AMVP mode, the Skip mode or the Merge mode.

2. The method of claim 1, wherein said one or more temporal neighboring blocks correspond to a temporal CT block and a temporal BR block, wherein the temporal CT block corresponds to a collocated center block associated with the current block and the temporal BR block corresponds to a collocated bottom-right block across from a bottom-right corner of the current block, wherein the center block is located at an upper-left, upper-right, below-left, or below-right location of a center point of the current block.

3. The method of claim 2, wherein the temporal search order checks the temporal BR block first and the temporal CT block next.

4. The method of claim 1, wherein said one or more spatial neighboring blocks correspond to at least one of a left block, an above block, an above-right block, a bottom-left block and an above-left block of the current block.

5. The method of claim 1, wherein said one or more temporal neighboring blocks include a temporal BR block, the temporal BR block is included in the temporal search order if the temporal BR block is in a same CTU row as the current CTU, and the temporal BR block is omitted from the temporal search order if the temporal BR block is in the CTU below the current CTU row, and wherein the temporal BR block corresponds to a collocated bottom-right block across from a bottom-right corner of the current block.

6. The method of claim 1, wherein said one or more temporal neighboring blocks exclude a temporal TL block, wherein the temporal TL block corresponds to a collocated top-left block of the current block.

7. The method of claim 1, wherein said one or more temporal neighboring blocks for determining the derived DV are also used for determining a motion vector prediction (MVP) candidate used for the AMVP mode or the Merge mode.

8. The method of claim 1, wherein said one or more temporal neighboring blocks, the temporal searching order, and any constraint on said one or more temporal neighboring blocks used to determine the derived DV are also used to derive a motion vector prediction (MVP) candidate used for the AMVP mode or the Merge mode.

9. The method of claim 1, wherein said searching said one or more spatial neighboring blocks and said one or more temporal neighboring blocks to determine the derived DV is according to a spatial-temporal search order selected from a second group comprising:
a) checking first DVs (disparity vectors) of said one or more spatial neighboring blocks, followed by checking second DVs of said one or more temporal neighboring blocks, and followed by checking third DVs used by said one or more spatial neighboring blocks for inter-view motion prediction;
b) checking the second DVs of said one or more temporal neighboring blocks, followed by checking the first DVs (disparity vectors) of said one or more spatial neighboring blocks, and followed by checking the third DVs used by said one or more spatial neighboring blocks for the inter-view motion prediction; and
c) checking fourth DVs of one or more first temporal neighboring blocks of a first temporal picture, followed by checking the first DVs (disparity vectors) of said one or more spatial neighboring blocks, followed by checking fifth DVs of one or more second temporal neighboring blocks of one first temporal picture, and followed by checking the third DVs used by said one or more spatial neighboring blocks for the inter-view motion prediction.

10. A method of coding a block using a derived DV (disparity vector) for a three-dimensional or multi-view video coding system, the method comprising:
receiving input data associated with a current block of a current CTU (coding tree unit) in a current dependent view;
identifying one or more spatial neighboring blocks and one or more temporal neighboring blocks of the current block;
searching said one or more spatial neighboring blocks and said one or more temporal neighboring blocks to determine the derived DV according to a spatial-temporal search order, wherein said one or more temporal neighboring blocks are searched before said one or more spatial neighboring blocks; and
applying video encoding or decoding to the input data using the derived DV, wherein the derived DV is used for a coding tool selected from a group comprising:
a) indicating a first prediction block in a first reference view for inter-view motion prediction of the current block in AMVP (advance motion vector prediction) mode, Skip mode or Merge mode;
b) indicating a second prediction block in a second reference view for inter-view residual prediction of the current block; and
c) predicting a first DV of a DCP (disparity-compensated prediction) block for the current block in the AMVP mode, the Skip mode or the Merge mode.

11. The method of claim 10, wherein said one or more temporal neighboring blocks are checked according to a temporal search order, and the temporal search order is the same for all dependent views.

12. The method of claim 11, wherein said one or more temporal neighboring blocks include a temporal BR block, the temporal BR block is included in the temporal search order if the temporal BR block is in a same CTU row as the current CTU, and the temporal BR block is omitted from the temporal search order if the temporal BR block is in the CTU below a current CTU row, and wherein the temporal BR block corresponds to a collocated bottom-right block across from a bottom-right corner of the current block.

13. The method of claim 10, wherein the spatial-temporal search order checks first DVs (disparity vectors) of said one or more spatial neighboring blocks and then checks second DVs used by said one or more spatial neighboring blocks for inter-view motion prediction.

14. The method of claim 10, wherein said one or more temporal neighboring blocks exclude a temporal TL block, wherein the temporal TL block corresponds to a collocated top-left block of the current block.

15. The method of claim 10, wherein said one or more temporal neighboring blocks correspond to a collocated center block associated with the current block and a collocated bottom-right block across from a bottom-right corner of the current block, and wherein said one or more spatial neighboring blocks correspond to at least one of a left block, an above block, an above-right block, a bottom-left block and an above-left block of the current block, and wherein the center block is located at an upper-left, upper-right, below-left, or below-right location of a center point of the current block.

16. An apparatus for coding a block using a derived DV (disparity vector) for a three-dimensional or multi-view video coding system, the apparatus comprising one or more electronic circuits, wherein said one or more electronic circuits are configured to:
receive input data associated with a current block in a current dependent view;
identify one or more spatial neighboring blocks and one or more temporal neighboring blocks of the current block;
search said one or more spatial neighboring blocks and said one or more temporal neighboring blocks to determine the derived DV, wherein said one or more temporal neighboring blocks are searched according to a temporal search order, the temporal search order is the same for all dependent views, and any temporal neighboring block from a CTU (coding tree unit) below a current CTU row is omitted in the temporal search order; and
apply video encoding or decoding to the input data using the derived DV to a coding tool selected from a group comprising:
a) indicate a first prediction block in a first reference view for inter-view motion prediction of the current block in AMVP (advance motion vector prediction) mode, Skip mode or Merge mode;
b) indicate a second prediction block in a second reference view for inter-view residual prediction of the current block; and
c) predict a first DV of a DCP (disparity-compensated prediction) block for the current block in the AMVP mode, the Skip mode or the Merge mode.

17. An apparatus for coding a block using a derived DV (disparity vector) for a three-dimensional or multi-view video coding system, the apparatus comprising one or more electronic circuits, wherein said one or more electronic circuits are configured to:
receive input data associated with a current block in a current dependent view;
identify one or more spatial neighboring blocks and one or more temporal neighboring blocks of the current block;
search said one or more spatial neighboring blocks and said one or more temporal neighboring blocks to determine the derived DV according to a spatial-temporal search order, wherein said one or more temporal neighboring blocks are searched before said one or more spatial neighboring blocks; and
apply video encoding or decoding to the input data using the derived DV to a coding tool selected from a group comprising:
a) indicate a first prediction block in a first reference view for inter-view motion prediction of the current block in AMVP (advance motion vector prediction) mode, Skip mode or Merge mode;
b) indicate a second prediction block in a second reference view for inter-view residual prediction of the current block; and
c) predict a first DV of a DCP (disparity-compensated prediction) block for the current block in the AMVP mode, the Skip mode or the Merge mode.
